(19) United States
(12) Patent Application Publication
(10) Pub. No.: US 2024/0013143 A1
(43) Pub. Date: Jan. 11, 2024

(54) STORAGE POSITION DETERMINATION SYSTEM, STORAGE POSITION DETERMINATION METHOD, AND STORAGE MEDIUM

(71) Applicant: TOYOTA JIDOSHA KABUSHIKI KAISHA, Toyota-shi (JP)

(72) Inventors: Yohei MORIKUNI, Toyota-shi (JP); Yoshiumi KAWAMURA, Suntou-gun (JP); Makoto TANIGUCHI, Hadano-shi (JP)

(73) Assignee: TOYOTA JIDOSHA KABUSHIKI KAISHA, Toyota-shi (JP)

(21) Appl. No.: 18/195,476

(22) Filed: May 10, 2023

(30) Foreign Application Priority Data
Jul. 7, 2022 (JP) 2022-109605

(51) Int. Cl. G06Q 10/087

(52) U.S. Cl. CPC G06Q 10/087

(57) ABSTRACT

A storage position determination system performs input processing, calculation processing, and determination processing. The input processing receives, for each of multiple articles to be stored in a predetermined area, article information indicating an article, storage position information indicating the storage position of the article, carrying in/out information chronologically indicating the number of carrying in/out pieces of the article, and moving route information indicating moving routes used for work for carried articles that are one or more articles indicated by the carrying in/out information and are carried in or out at the same time. The calculation processing calculates candidates for a new position of a storage position for at least one of the articles such that a first condition that the moving distance indicated by the moving route information is not increased is satisfied. The determination processing determines, for a candidate-calculated article, the new position from among the candidates.

### CROSS-REFERENCE TO RELATED APPLICATION

This application claims priority to Japanese Patent Application No. 2022-109605 filed on Jul. 7, 2022, incorporated herein by reference in its entirety.

### BACKGROUND

### 1. Technical Field

The present disclosure relates to a storage position determination system, a storage position determination method, and a storage medium.

### 2. Description of Related Art

Japanese Unexamined Patent Application Publication No. 2000-034004 (JP 2000-034004 A) describes an article management method used at a place for picking articles in order to improve the work efficiency of workers.

### SUMMARY

According to the technique described in JP 2000-034004 A, to avoid an increase in walking distance and congestion that may be caused during work, a simulation is performed while sequentially changing a combination of article storage positions. This technique may sometimes require a simulation of all combinations in order to find a combination of storage positions that avoids congestion without increasing walking distance. It is therefore desired to determine the placement of articles in such a way that the efficiency of article storage work is improved with a small amount of calculation processing.

To solve such a problem, it is an object of the present disclosure to provide a storage position determination system, a storage position determination method, and a storage medium that make it possible to determine the placement of articles in such a way that the efficiency of article storage work is improved with a small amount of calculation processing.

A storage position determination system according to the present disclosure is configured to perform input processing, calculation processing, and determination processing. The input processing is configured to receive, for each of a plurality of articles to be stored in a predetermined area, article information, storage position information, carrying in/out information, and moving route information. The article information indicates the article. The storage position information indicates a storage position when the article is stored. The carrying in/out information indicates, in chronological order, the number of carrying-in pieces of the article and the number of carrying-out pieces of the article. The moving route information indicates moving routes at a time of work for carried articles that are one or more articles indicated by the carrying in/out information and that are carried in or carried out at the same time. The calculation processing is configured to calculate candidates for a new position of a storage position for at least one of the plurality of articles in such a way that a first condition is satisfied. The first condition is a condition that the moving distance indicated by the moving route information is not increased. The determination processing is configured to determine, for a candidate-calculated article, the new position from among the candidates. The candidate-calculated article is an article for which the candidates have been calculated. This configuration of the storage position determination system makes it possible to determine the placement of articles in such a way that the efficiency of the work involved in storing articles is improved with a small amount of calculation processing.

A storage position determination method according to the present disclosure includes performing input processing, performing calculation processing, and performing determination processing. The input processing is configured to receive, for each of a plurality of articles to be stored in a predetermined area, article information, storage position information, carrying in/out information, and moving route information. The article information indicates the article. The storage position information indicates a storage position when the article is stored. The carrying in/out information indicates, in chronological order, the number of carrying-in pieces of the article and the number of carrying-out pieces of the article. The moving route information indicates moving routes at a time of work for carried articles that are one or more articles indicated by the carrying in/out information and that are carried in or carried out at the same time. The calculation processing is configured to calculate candidates for a new position of a storage position for at least one of the plurality of articles in such a way that a first condition is satisfied. The first condition is a condition that the moving distance indicated by the moving route information is not increased. The determination processing is configured to determine, for a candidate-calculated article, the new position from among the candidates. The candidate-calculated article is an article for which the candidates have been calculated. This configuration of the storage position determination method makes it possible to determine the placement of articles in a such way that the efficiency of the work involved in storing articles is improved with a small amount of calculation processing.

A storage medium according to the present disclosure stores a program that causes a computer to perform input processing, calculation processing, and determination processing. The input processing is configured to receive, for each of a plurality of articles to be stored in a predetermined area, article information, storage position information, carrying in/out information, and moving route information. The article information indicates the article. The storage position information indicates a storage position when the article is stored. The carrying in/out information indicates, in chronological order, the number of carrying-in pieces of the article and the number of carrying-out pieces of the article. The moving route information indicates moving routes at a time of work for carried articles that are one or more articles indicated by the carrying in/out information and that are carried in or carried out at the same time. The calculation processing is configured to calculate candidates for a new position of a storage position for at least one of the plurality of articles in such a way that a first condition is satisfied. The first condition is a condition that the moving distance indicated by the moving route information is not increased. The determination processing is configured to determine, for a candidate-calculated article, the new position from among the candidates. The candidate-calculated article is an article for which the candidates have been calculated. This configuration of the program makes it possible to determine the placement of articles in such a way that the efficiency of the work involved in storing articles is improved with a small amount of calculation processing.

One or more of the following various configurations can be applied to any of the storage position determination system, the storage position determination method, and the storage medium.

The first condition may include a condition that the new position is a storage position to which movement along the moving route indicated by the moving route information is possible, and the calculation processing may be configured to calculate at least one of the candidates in such a way that the condition is satisfied.

The calculation processing may be configured to calculate, as the at least one of the candidates, a storage position where at least parts of the moving routes indicated by the moving route information overlap each other in such a way that the condition is satisfied.

The article information may include information indicating the size of the article, and the calculation processing may be configured to calculate the candidates from among storage positions that are able to accommodate the article indicated by the article information.

All moving routes indicated by the moving route information may be routes where moving to a storage position is limited to moving from a predetermined direction.

For an article that is included in the plurality of articles but that is not included in the carrying in/out information or for an article that is included in the plurality of articles but for which the number of carrying-in pieces and the number of carrying-out pieces in the carrying in/out information are zero, the calculation processing may be configured not to calculate the candidates or is configured to calculate, as the candidates, the same storage position as the storage position.

The determination processing may be configured to determine the new position from among the candidates in such a way that the work amount required for carrying articles in, and carrying articles out from, storage positions in the predetermined area is distributed over the storage positions.

The article information may include information indicating the size of the article, the storage position information may include information indicating the size of a storage area or the number of pieces that is able to be stored for each of the plurality of articles, and the determination processing may be configured to determine, as the new position from among the candidates, a storage position where the candidate-calculated article is able to be stored, based on the article information and the storage position information.

The article information may include information indicating an attention level in carrying the article, and the determination processing may be configured to determine, as the new position from among the candidates, a storage position where the candidate-calculated article is able to be carried and stored without damage, based on the information indicating the level.

At least one of the moving routes indicated by the received moving route information may be a route calculated as a route that is estimated to be followed when the carried articles are carried in or carried out.

The present disclosure can provide the storage position determination system, the storage position determination method, and the storage medium that make it possible to determine the placement of articles in such a way that the efficiency of article storage work is improved with a small amount of calculation processing.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing one configuration example of a storage position determination system according to an embodiment;

FIG. 2 is a schematic diagram showing an example of storage position determination processing performed by the storage position determination system shown in FIG. 1;

FIG. 3 is a schematic diagram showing an example of the layout of shelves and the placement of articles in a warehouse;

FIG. 4 is a diagram showing an example of work orders;

FIG. 5 is a flowchart showing a more specific example of storage position determination processing performed by the storage position determination system shown in FIG. 1;

FIG. 6 is a schematic diagram showing an example of processing for calculating assignable position candidates for articles in the example shown in FIG. 3;

FIG. 7 is a diagram showing an example of assignable position candidates calculated in the processing example shown in FIG. 6;

FIG. 8 is a flowchart showing another more specific example of storage position determination processing performed by the storage position determination system shown in FIG. 1; and

FIG. 9 is a diagram showing an example of the hardware configuration of a device.

### DETAILED DESCRIPTION OF EMBODIMENTS

While the present disclosure will be described using an embodiment of the disclosure, it should be noted that the disclosure according to claims is not limited to the embodiment described below. It should be also noted that not all of the configurations described in the embodiment are essential to solve the problem.

### EMBODIMENT

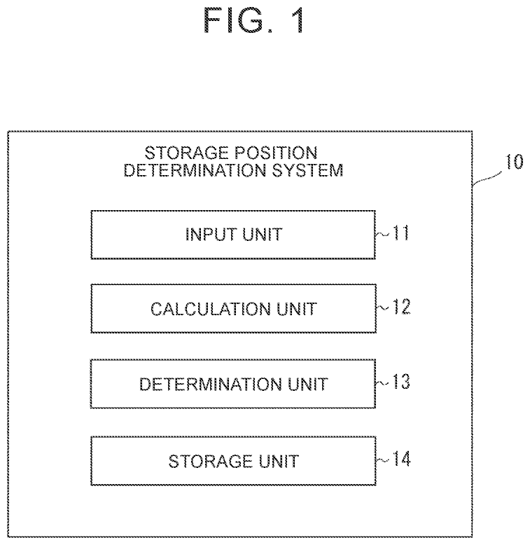

One configuration example of a storage position determination system according to the embodiment will be described with reference to FIG. 1 to FIG. 8. First, one configuration example of the storage position determination system according to the embodiment will be described with reference to FIG. 1. FIG. 1 is a block diagram showing one configuration example of the storage position determination system (hereinafter referred to as the system) according to the embodiment.

A system 10 shown in FIG. 1 is a system that determines the storage position of each of a plurality of articles to be stored in a predetermined area. The system may be configured with the functions distributed over a plurality of devices or may be configured as a single device.

The stored articles may be articles different from each other, meaning that the stored articles may include articles having different sizes and weights. Typically, the stored articles may be articles of different types (model numbers, etc.), in which case the stored articles are articles of a plurality of types. Actually, however, articles of the same type may also be treated as different articles. The stored articles may also include, for example, a set of a plurality of parts of one type for manufacturing a certain product or a set of parts of a plurality of types for manufacturing a certain product.

The predetermined area is, for example, one warehouse or a plurality of warehouses on the same site, but is not limited to them. There is a plurality of article storage spaces, and some or all of storage spaces may have different sizes and shapes. Articles are stored in spaces including, but not limited to, shelves.

Articles may be stored by a worker, by an autonomous mobile robot that works as a working robot, or by both.

As shown in FIG. 1, the system 10 may include an input unit 11 that performs information input processing, a calculation unit 12 that performs calculation processing, and a determination unit 13 that performs determination processing. The system 10 may also include a storage unit 14 that is a storage device for storing information such as that used in the processing described above. The input processing, calculation processing, and determination processing will be described later.

The input unit 11 may be configured by an interface, such as an input interface for receiving information from the storage unit 14 or a communication interface for receiving information from an external device including a server device connected externally to the system 10, and an input control unit that controls the reception of information.

The input control unit, calculation unit 12, and determination unit 12 may be provided as a control unit that controls the entire operation of the system 10. This control unit, configured, for example, by an integrated circuit, can be implemented by the components including a processor (such as a central processing unit (CPU)), a working memory, and a non-volatile storage device. In this storage device, the control program for execution by the processor is stored. The processor reads the program into the working memory for performing the input control function of the input control unit, the function of the calculation unit 12, and the function of the determination unit 13. The storage unit 14 can use a part of the storage area of this storage device.

The input unit 11 performs input processing to receive article information, storage position information, carrying in/out information, and moving route information for each of the above-described articles. These pieces of information may be stored in, and received from, the storage unit 14 as in the example given below. Instead, these pieces of information may also be stored in, and read from, the above-described external device. The input unit 11 passes a part or all of the received information to the calculation unit 12 and the determination unit 13.

The article information is the information indicating an article, such as an article number that can identify the article from other articles. The storage position information is the information indicating, for each of the articles, the storage position when the article is stored. For example, when a plurality of shelves is provided as storage positions, the storage position information can include the information that can uniquely identify a shelf, such as a shelf number, from the other shelves. For the storage position where an article is stored, the storage position information includes, or is associated with, the article information. The storage position information received by the input unit 11 is the information indicating the storage position before the final storage position of the article is determined. Note that the storage position information may also be the information that includes the information indicating the position where an article can be stored but that does not include, nor is associated with, the article information. In that case, the article information includes or is associated with the storage position information.

The carrying in/out information is the information indicating, in chronological order, the number of carrying-in pieces, and the number of carrying-out pieces, of an article. For example, in the above-described articles, when there is a plurality of pieces of an article that is treated as the same article, there can be a plurality of carrying-in pieces, and carrying-out pieces, of that article at a given date and time.

The moving route information is the information indicating a moving route used at a time of work for carried articles that are one or more articles indicated by the carrying in/out information and that are carried in or carried out at the same time. In a simple example, the moving route of a plurality of articles carried or carried out at the same time can be calculated in advance as follows. That is, the moving route can be calculated in advance, for example, as a route by connecting the shortest routes among the articles. The shortest routes include the shortest route from the carrying start position or the retrieval start position to the storage position of the nearest article indicated by the storage position information, the shortest route from the storage position of that article to the storage position of another nearest article, and so on. Also, the moving route of a plurality of articles that are carried or carried out at the same time may be calculated in advance by solving an optimization problem that provides the shortest distance based on each of the storage positions of these articles. The carrying start position refers to the position where the work of carrying articles to, and placing them in, their storage positions is started, and the retrieval start position refers to the position where the work of moving to the storage positions of articles to pick them up is started.

The moving route information is the information indicating the moving routes at the time of work for carried articles that are carried in or carried out at the same time as described above. The moving route information does not need to include the information indicating the date and time at which the articles are carried. For example, when the carrying time limit, or the movement date, of the articles is known at the time of generating the moving route information, the information about the articles that are carried in or carried out at the same time, if available, is necessary. However, the moving route information may include the information indicating the movement date and time and, in this case too, there is no need to use this included information.

The calculation unit 12 performs calculation processing to calculate candidates for a new position of a storage position for at least one of the above-described articles in such a way that a condition is satisfied. The condition is that the moving distance indicated by the moving route information received by the input unit 11 is not increased (hereinafter, this condition is referred to as the first condition). The calculation unit 12 can perform this calculation processing by referring not only to the moving route information but also to the article information, storage position information, and carrying in/out information all of which are the information received by the input unit 11 as the information other than the moving route information. In this way, the calculation unit 12 can calculate candidates using all or part of the information received by the input unit 11.

The moving distance described above refers to the walking distance when a worker walks to carry articles, or refers to the total of the walking distance of a worker and the moving distance of a vehicle when the worker rides on the vehicle to carry articles. The moving distance refers to the moving distance of a working robot when the working robot carries articles.

The storage position, that is, the storage space, of a certain article can also be also referred to as an assigned position to which the placement position of the article is assigned, and the candidates for a new position refer to the candidates for the assigned position. The calculation unit 12, which performs calculation to acquire the candidates for an assigned position in this way, can also be referred to as an assignable position candidate acquisition unit.

The first condition is that the moving distance is not increased. Therefore, when the number of carried articles indicated by the received moving route information is one, the first condition naturally means that the moving distance indicated by the moving route information is not increased. When the number of carried articles indicated by the received moving route information is two or more, the first condition means that the moving distance for moving the articles, indicated by the moving route information, is not increased.

The determination unit 13 performs determination processing to determinate, for a candidate-calculated article that is an article for which candidates have been calculated by the calculation unit 12, a new position (that is, newly assigned position) from among the candidates. The determination unit 13 can determine the newly assigned position of the candidate-calculated article, using the information indicating the assignable position candidates, which are candidates for the candidate-calculated article, and all or part of the information received by the input unit 11.

After that, based on the new position determined by the determination processing, the system 10 can be configured to perform change processing that changes the storage position information. It is assumed in the description below that the determination unit 13 also performs this change processing. That is, the determination unit 13 determines the assigned position of a candidate-calculated article and then, by changing the assigned position according to the determination, changes the storage position information. Therefore, the determination unit 13 can be called an assigned position changing unit. A worker or a working robot can store the articles based on the changed storage position information.

The system 10, configured as described above, can find a new storage position with a small amount of calculation processing without increasing the moving distance of a worker or a working robot over the moving distance from the current storage position. That is, the system 10 makes it possible to determine the storage position of articles so that the efficiency of article-storage-related work improves with a small amount of calculation processing. In addition, the system 10 allows the work amount information to be implicitly or explicitly included in the moving route information and, based on such moving route information, determines a new position (storage space). Therefore, the determined storage position prevents a heavy workload from being placed on a worker or a working robot, reducing the possibility of congestion.

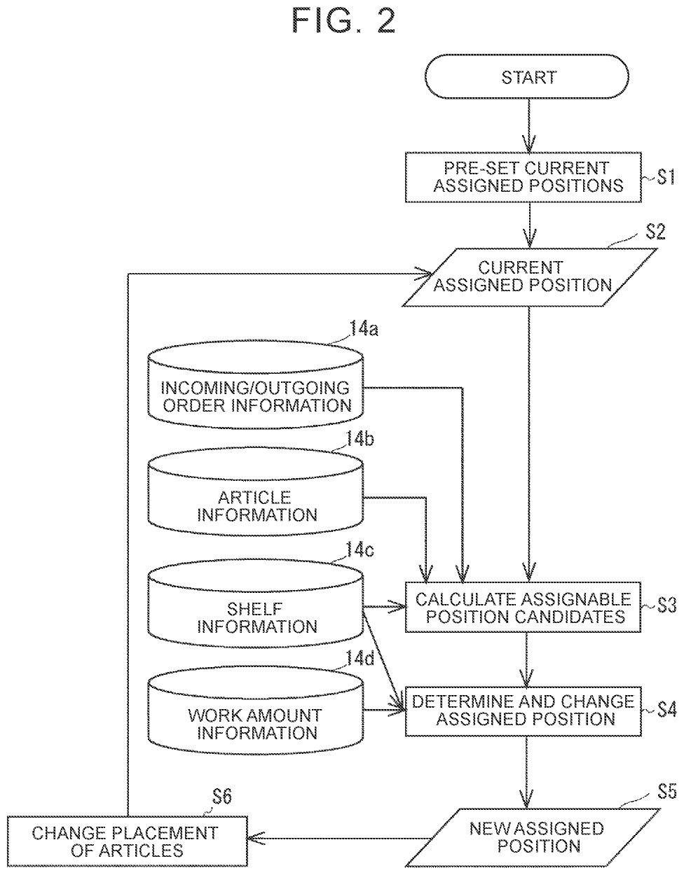

Next, an example of storage position determination processing performed by the system 10 will be described with reference to FIG. 2. FIG. 2 is a schematic diagram showing an example of the storage position determination processing performed by the storage position determination system 10 shown in FIG. 1.

In the example shown in FIG. 2, it is assumed that the storage unit 14 stores therein the following information: article information 14b on each of the above-described articles, shelf information 14c as an example of the storage position information, incoming/outgoing order information 14a as an example of the carrying in/out information, and work amount information 14d as an example of the moving route information. In the storage unit 14, each piece of information 14a to 14d can be stored in a database format.

The incoming/outgoing order information 14a is the carrying in/out information when carrying-in and carrying-out are carrying-in and carrying-out for a warehouse respectively. This information is the information indicating orders to perform storage/retrieval work. That is, in this example, the articles are managed in a warehouse that is an example of the predetermined area. The shelf information 14c is the storage position information when the storage positions are shelves in a warehouse. That is, in this example, one of a plurality of shelves, installed in the warehouse, is used as a storage position. Note that, though a shelf is used as an assigned position for storing articles for the sake of convenience in the description below, the assigned position for storing articles is not limited to a shelf.

The work amount information 14d is the information indicating the work amount including the moving distance required for carrying articles. This information can be received as the moving route information. Alternatively, the work amount information 14b can be stored as a calculation result calculated based on the received moving route information. The work amount information 14d can be the information that is obtained from the past performance data and the forecast data on the storage/retrieval of articles and that indicates the work amount including the moving distance for each article.

First, in the system 10, the current assigned positions are pre-set, for example, by the input unit 11 (step S1). In step S1, the current assigned position information, which is the information indicating the current assigned positions, is stored into the storage unit 14. This information may be stored any time before step S2. The current assigned position information includes the shelf information 14c and, in addition, may include the article information 14b, incoming/outgoing order information 14a, and work amount information 14d.

The presetting of the current assigned positions refers to the processing in which the current assigned positions are determined in advance by a person and the determined assigned positions of the articles are input to the system 10 or refers to the processing in which the current assigned positions are automatically set by the function separately provided in the system 10 or in an external system.

The current assigned positions include assigned positions where articles are actually placed in a predetermined area such as a warehouse and assigned positions where articles are planned to be actually placed in a predetermined area such as a warehouse. The current assigned positions can also include both assigned positions. Note that, however, when the current assigned positions include both assigned positions, articles corresponding to the former assigned positions and articles corresponding to the former assigned positions are different in the determination of a new position. In more detail, when the processing in steps S2 to S6 described below is performed in the system 10, the assigned position is determined, in the former case, to be a new position by changing the actual placement so that the new position can improve work efficiency while the assigned position is determined, in the latter case, to be a new position by changing the planned placement so that the new position can improve work efficiency.

Next, the input unit 11 receives the current assigned position information and passes it to the calculation unit 12 (step S2). The calculation unit 12 calculates assignable position candidates that satisfy the first condition based on the current assigned position information and passes the calculated assignable position candidates to the determination unit 13 (step S3).

In step S3, the calculation unit 12 can calculate assignable position candidates, for example, as follows. First, based on the incoming/outgoing order information 14a, article information 14b, and shelf information 14c, the calculation unit 12 calculates preliminary candidates for the assigned position for each of the articles included in the incoming/outgoing order information 14a. Then, assuming that each preliminary candidates is the assigned position, the calculation unit 12 performs the processing to calculate moving routes that will be used at the time of work for each incoming/outgoing order. Next, from among the moving routes calculated assuming that each preliminary candidate is the assigned position, the calculation unit 12 extracts moving routes each of which does not exceed the moving distance that is indicated by the work amount information 14d included in the current assigned position information and, as the assignable position candidates, calculates the assigned positions of the preliminary candidates indicated by those moving routes.

In this way, in step S3, based on the current assigned position information and for the moving route of work indicated by each incoming/outgoing order, the calculation unit 12 calculates, for each of the articles included in the incoming/outgoing order information 14a, assignable position candidates each of which does not increase the moving distance of the moving route over that required for the current assigned position. In this case, when the incoming/outgoing order information 14a includes an article that does not satisfy the first condition that the moving distance is not increased, the calculation unit 12 assumes that there is no assignable position candidate for that article. Note that the calculation of assignable position candidates performed by the calculation unit 12 may be carried out, for example, using a learning model and, in the calculation of that learning model, any algorithm may be used.

After step S3, for an article (candidate-calculated article) for which assignable position candidates are calculated by the calculation unit 12, the determination unit 13 determines a new position (new article-assigned position) from among the assignable position candidates, and temporarily stores the determined new position (step S4).

The new position can be determined, for example, as follows. That is, based on the information indicating the assignable position candidates calculated for each article, based on the information such as that indicating the shelf positions included in the shelf information 14c, and based on the work amount information 14d on each article obtained from the past performance and the forecast data on the article storage/retrieval, the determination unit 13 calculates the new article-assigned position from among the assignable position candidates in such a way that work frequency or the work time is not concentrated on a specific shelf.

In step S4, the new article-assigned position is determined when the incoming/outgoing status of stored articles is changed. The new article-assigned position is determined also when the current assigned position is changed by addition to, or deletion from, the stored articles. Note that the calculation of the new assigned position by the determination unit 13 may also be performed, for example, using a learning model and, in the calculation of that learning model, any algorithm may be used.

The determination unit 13 reads the new article-assigned position determined and temporarily stored in step S4 (step S5) and, based on this new article-assigned position, changes the placement of articles in the system 10 by updating the shelf information 14c included in the current assigned position information (step S6).

The system 10 performs the processing described above to determine a new article-assigned position, where work is not concentrated on a specific shelf and the possibility of congestion is low, without increasing the moving distance of a worker or a working robot over the moving distance required for the current assigned position.

When the placement of the article, that is, the article-assigned position, is changed in step S6, it is also possible to return to step S2 for performing similar processing with the changed assigned position as the current assigned position. By doing so, an assigned position with a low possibility of congestion can be calculated again.

In the system 10, when the incoming/outgoing order information 14a has been accumulated to some extent since the last assigned-position change, it is preferable to perform recalculation to determine a new article-assigned position for changing the placement of an article. At the time of recalculation, the latest information can be reflected on the determination of article-assigned positions by performing recalculation using only the incoming/outgoing order information 14a that is a predetermined period of time before the recalculation time or by placing higher weight on newer incoming/outgoing order information 14a.

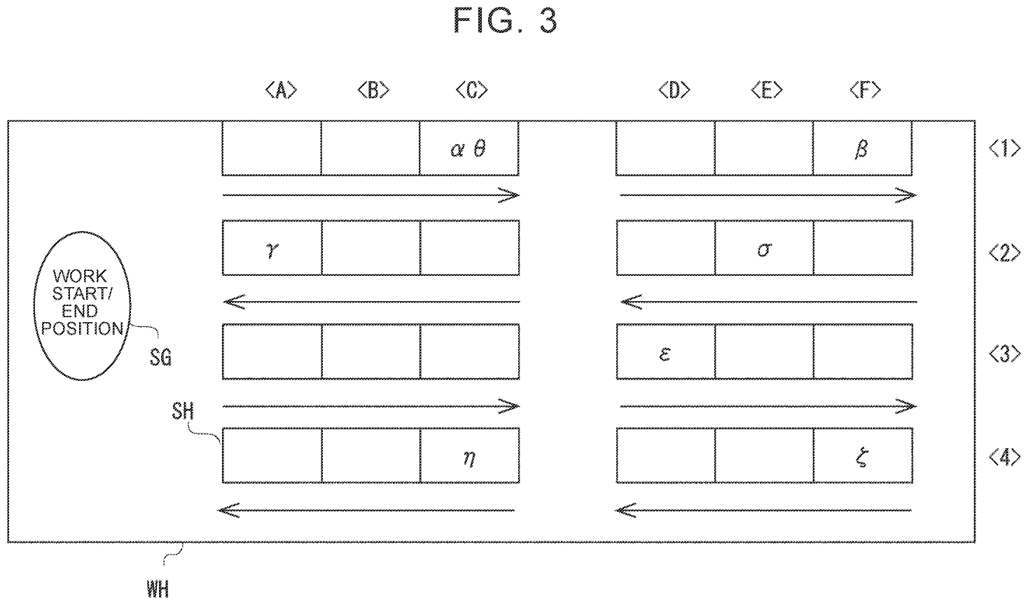

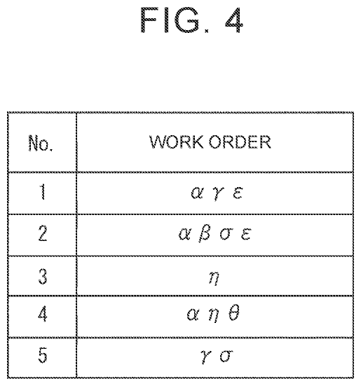

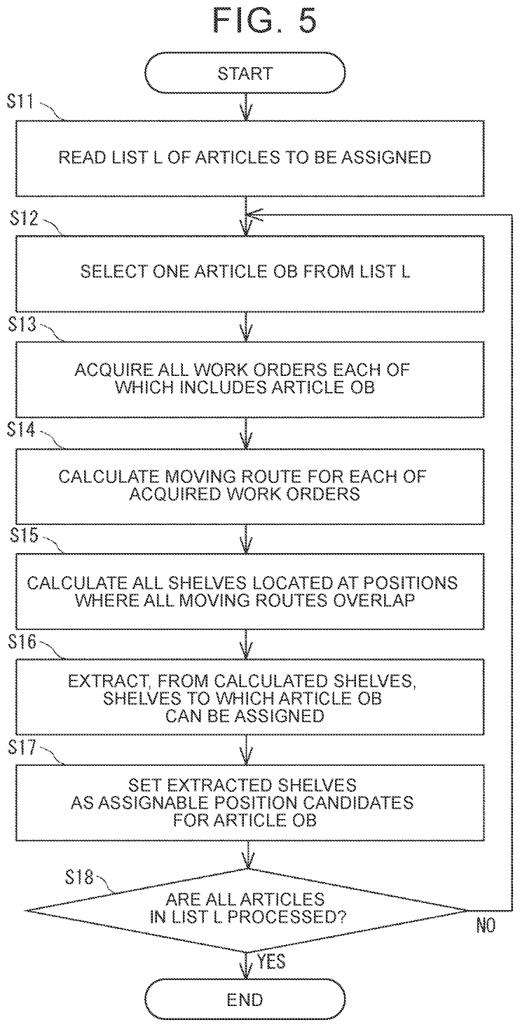

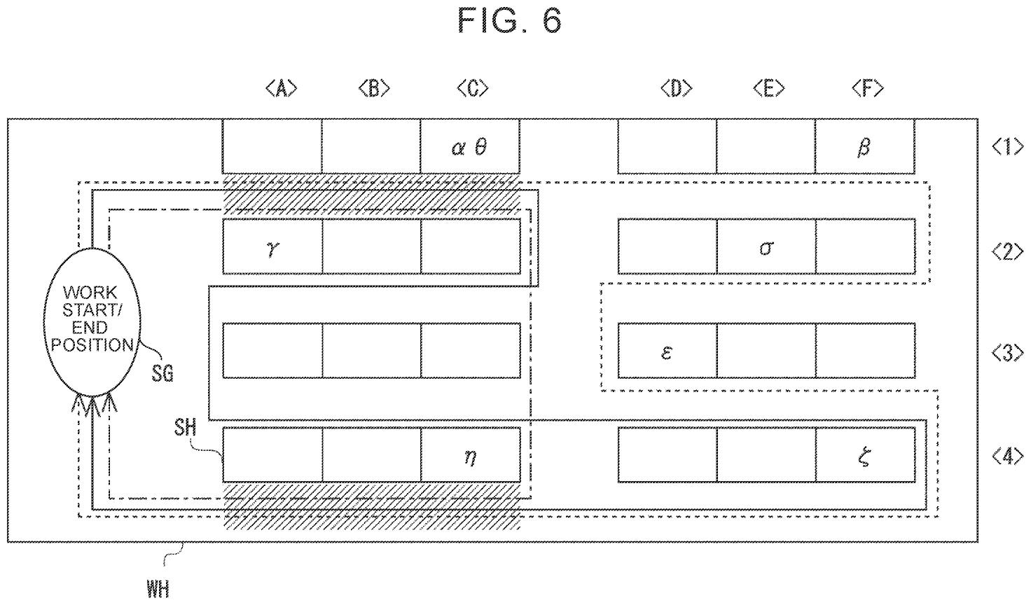

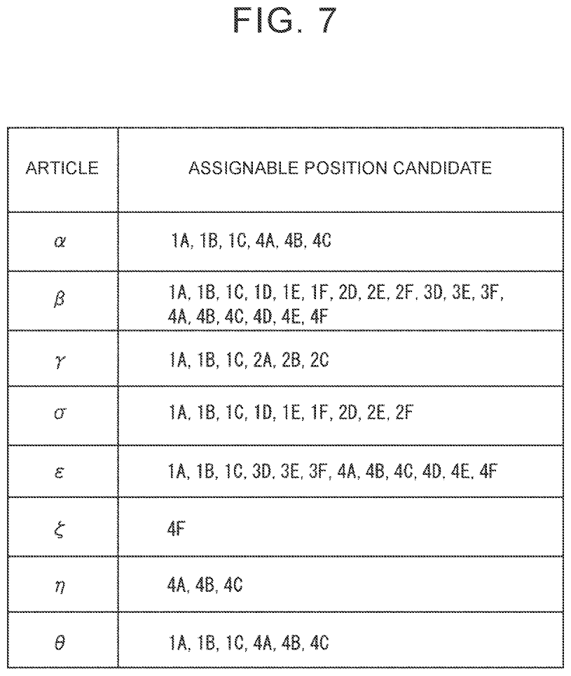

More specifically, a more detailed example of the system 10 will be described with reference to FIG. 3 to FIG. 7. FIG. 3 is a schematic diagram showing an example of the layout of shelves, and the placement of articles, in a warehouse. FIG. 4 is a diagram showing an example of work orders. FIG. 5 is a flowchart showing a more specific example of storage position determination processing performed in this system 10. FIG. 6 is a schematic diagram showing an example of processing for calculating assignable position candidates of the articles shown in the example in FIG. 3, and FIG. 7 is a diagram showing an example of assignable position candidates calculated in the processing example shown in FIG. 6.

First, the input unit 11 can acquire, for example, the information (i) to (iv), given below, as the input information and pass the acquired information to the calculation unit 12. Based on these pieces of information, the calculation unit 12 calculates, for each article, shelves (assignable position candidates) by which the assigned position can be changed in such a way that the moving distance required for performing work on each incoming/outgoing order is not increased over that required for the current assigned position.
(i) Information indicating the current assigned position of each article. This information is passed as a part of the shelf information 14c.
(ii) Information indicating the assignable-position condition necessary for setting an assigned position, such as the information indicating an article to be stored and the size of the article. This information is passed as the article information 14b.
(iii) Information indicating the incoming/outgoing order of articles that was performed in the past or is predicted to be performed in the future. This information is passed as the incoming/outgoing order information 14a.
(iv) Information indicating the arrangement layout of shelves, the information indicating passages, and the information indicating the assignable-position conditions necessary for setting assigned positions such as the size of a shelf. This information is passed as a part of the shelf information 14c. The information indicating passages includes the passage information such as passage prohibition or one-way movement and the information on article-carrying rules (such as order of work and method of route selection) to be observed by a worker or a working robot.

For the information (iii) above, an incoming/outgoing order is given as an order of one article, or as an order of a set of a plurality of articles, for each work. When one incoming order or one outgoing order is given, a worker or a working robot carries articles from the work-start position to the shelf to which each of the articles included in the given incoming/outgoing order is assigned, performs storage work or retrieval work corresponding to the incoming/outgoing order, and returns to the work-end position when the work for all articles is completed.

To simplify the description, an example of processing of the calculation unit 12 will be described below using a scene that satisfies the following first to sixth premises. Processing of the determination unit 13 will be described later also by using this scene.

First, as shown in FIG. 3, the shelves SH are arranged in a layout of four rows and six columns in the warehouse WH, and each shelf SH is numbered with a combination of a row number (1 to 4) and a column number (A to F). An article can be stored on, or retrieved from, each shelf SH through the passage on the lower side in FIG. 3. In FIG. 3, numbers shown in < > are row numbers, and alphabets shown in < > are column numbers. Second, there are eight articles indicated by α, β, γ, δ, ε, ζ, η, and θ, and their current assigned positions are given by the storage positions shown in FIG. 3. For example, the current assigned position is set for articles α and θ assuming that both articles are stored in the shelf SH in row 1, column C. Third, it is assumed that, as the incoming/outgoing order information 14a, the information shown in FIG. 4 is given.

Fourth, it is assumed that the shelf is large enough that any article can be assigned to it and that there is no administrative distinction between a single-level shelf and a multi-level shelf. Fifth, it is assumed that the work starts from the work start/end position SG shown in FIG. 3 and returns to the work start/end position SG. Sixth, it is assumed that, in the passages marked with arrows in FIG. 3, a worker or a working robot is allowed to move only in the direction of arrows.

In such a scene, the calculation unit 12 calculates assignable position candidates in such a way that the first condition is satisfied. The first condition described above is a condition that the moving distance indicated by the moving route information received by the input unit 11 is not increased. In this scene, the first condition corresponds to a condition that the moving distance should not be increased over that required for the current assigned position shown in FIG. 3.

While other ideas can be used as an example of the basic idea of changing an assigned position in such a way that the moving distance is not increased over that required for the current assigned position, an example of the following idea is used in the description below. That is, for one article (for example, article OB), the moving routes for all the work orders each of which includes the article OB are calculated, and the shelves where all the calculated moving routes overlap are calculated. Then, the assignable shelves that satisfy the assignable-position condition, such as the size of article OB, are determined to be assignable position candidates that do not increase the moving distance of the article OB.

First, from the article information 14b, the input unit 11 acquires all the articles to be assigned and passes the acquired articles to the calculation unit 12 as a list L (step S11). The articles to be assigned can be all the articles managed in the warehouse WH. Next, the calculation unit 12 selects one article OB from the article list L (step S12). For example, the article α at the position shown in FIG. 3 can be selected as the article OB. Next, from the incoming/outgoing order information 14a, the calculation unit 12 acquires the work orders each of which includes the selected article OB (step S13). When the selected article OB is the article α, three work orders 1, 2, and 4 in FIG. 4 are acquired.

Next, the calculation unit 12 calculates the moving route for each of the acquired work orders according to a predetermined carrying rule (step S14). The moving route, which is a moving route used at the time of work, can also be called a work route. For the work orders 1, 2, and 4 in FIG. 4, the routes are shown by the solid line, broken line, and alternate long and short dash line in FIG. 6, respectively.

Next, the calculation unit 12 calculates the shelves located at a position where all the calculated moving routes overlap (step S15). The positions where all the moving routes 1, 2, and 4 overlap are the positions indicated by shaded lines in FIG. 6, meaning that shelves 1A, 1B, 1C, 4A, 4B, and 4C in the shaded lines are the calculated shelves. After that, from the calculated shelves, the calculation unit 12 extracts shelves to which the article can be assigned (step S16). When the article a is selected, shelves 1A, 1B, 1C, 4A, 4B, and 4C are extracted.

The calculation unit 12 sets the extracted shelves as the assignable position candidates for the selected article (step S17). For the article α, shelves 1A, 1B, 1C, 4A, 4B, and 4C are given and set as the assignable position candidates.

Since the assignable position candidates of an article obtained by the processing described above are on the moving routes of all the work orders that include the article, the moving distance is not increased even when the assigned position is changed to a position included at least in the calculated assignable position candidates.

Next, the calculation unit 12 determines whether unprocessed articles are in the list L (step S18). When unprocessed articles are in the list L, the processing returns to step S12 to repeat the processing until the determination result in step S18 becomes No, that is, until the processing is completed for all the articles.

In this way, the calculation unit 12 calculates assignable position candidates for all the articles. Note that, for an article that is not included in the work orders (article ζ in the example in FIG. 3), only the setting position of the current assigned position is used as an assignable position candidate. In this way, for an article that is included in the above-described articles but that is not included in the received carrying in/out information or for an article that is included in the plurality of articles but for which the number of carrying-in pieces and the number of carrying-out pieces in the received carrying in/out information are zero, the calculation unit 12 may calculate, as an assignable position candidate, the storage position that is same as the storage position. Alternatively, for such an article, the calculation unit 12 may omit the calculation of assignable position candidates.

When the processing shown in FIG. 5 is performed, the assignable position candidates for the articles shown in the example in FIG. 3 are given as in FIG. 7.

Next, a detailed example of the determination unit 13 will be described. First, the calculation unit 12 can pass the information (I), given below, to the determination unit 13, and the input unit 11 can acquire the information (II) and (III), given below, as the input information and pass the acquired information to the determination unit 13. Based on these pieces of information, the determination unit 13 determines an article-assigned position in such a way that, while limiting the assigned position of each article to the assignable position candidates, the amount of work performed on the shelves is distributed.
(I) Information indicating the assignable position candidates for each article calculated by the calculation unit 12
(II) Shelf information such as the number of pieces of each article that can be assigned to a shelf. This is passed as part of the shelf information 14c.
(III) Information indicating the work amount required for each article. This information is passed as the work amount information 14d.

The work amount required for each article described above includes the information such as the time it takes for the article to be stored on, or retrieved from, the shelf, the number of pieces of the article stored or retrieved in a fixed period, and the product of the time and the number of pieces described above. This information can be selected according to the purpose. It is also assumed that these values of an article are given in advance based on the past storage/retrieval results and the prediction.

The article-assigned position that allows the work amount to be distributed is the article-assigned position that minimizes the work amount distribution value V given by the equation (1) shown below. In the equation (1), S is a set of shelves, ISI is the number of shelves, and Ws is the work amount of shelf sεS. Ws is given by the total value of the work amounts of the articles assigned to the shelf s.

### [Equation 1]

$$V = \frac{1}{\vert S \vert} {\sum }_{s ∈ S} {( \frac{{\sum }_{{s}^{′} ∈ S} {W}_{{s}^{′}}}{\vert S \vert} - {W}_{s} )}^{2} \qquad ( 1 )$$

$$Total = {\sum }_{{s}^{′} ∈ S} {W}_{{s}^{′}} \qquad ( 2 )$$

$${V}^{′} = {\sum }_{s ∈ S} {W}_{s}^{2} \qquad ( 3 )$$

$${V}^{″} = {\sum }_{s ∈ S} f ( {W}_{s} ) \qquad ( 4 )$$

For example, as a method for determining the article-assigned position, the determination unit 13 can use the following method to determine the new article-assigned position. That is, the determination unit 13 can determine the new article-assigned position as an exact solution or a feasible solution by configuring a combinatorial optimization problem, in which the objective function is V given above and the article-assigned position is limited to the assignable position candidates, and by using a method for solving the combinatorial optimization problem such as a search method (for example, the branch and bound method) and an approximation algorithm (for example, smoothing).

In this way, the determination unit 13 may determine the new article-assigned position from among the assignable position candidates in such a way that the work amount required for carrying articles in and out from the storage positions in a predetermined area is distributed over the storage positions. As described above, the information indicating this work amount can be included implicitly (calculable from the carrying route information) or directly in the carrying route information. Distributing the work amount over the storage positions means, for example, that the total of work amounts becomes equal among the storage positions. Therefore, as modifications, the determination unit 13 can also perform the processing such as that in the following two examples.

In the example given above, since the determination unit 13 determines the article-assigned position in such a way that the amount of work performed on the shelves SH is distributed, the above equation (1), which is the variance of the amount of work performed on shelves SH, is given as the objective function. On the other hand, since both the number of shelves |S| and ‘Total’ in the above equation (2), which is the total of the work amounts of all the shelves, are constant regardless of the assignment, the determination unit 13 according to the modification uses the amount V′, instead of the variance V, in the above equation (3) as the objective function to calculate the new article-assigned position. In terms of solving the optimization problem, the use of such an objective function is equivalent to the use of the variance value V.

In addition, since the total of the work amounts of all the shelves SH is constant, the work amount on the shelves SH becomes more distributed as the number of shelves SH with large work amounts decreases. Therefore, as another modification, the determination unit 13 can also achieve a similar purpose by using the amount V″, which is given above by the equation (4) using a strictly monotonically increasing function f instead of the identity function, as an objective function other than above-described V and V′.

As described above, based on the storage positions of given articles and based on the carrying in/out information on the storage/retrieval of articles, the system 10 can determine the storage positions of the articles in such a way that the current moving distance of a worker or a working robot required for the work, such as picking, is not increased and that the number of times storage/retrieval work is performed at the storage positions is equalized.

To describe this effect, a comparison example in which this embodiment is not used is described. In this comparison example, it is assumed that the storage positions of articles are determined in such a way that, in a warehouse where articles are stored, only the moving distance required for picking or storing is shortened in order to improve work efficiency. In this comparison example, the storage positions of articles are concentrated in a specific part and, therefore, the possibility that two or more workers or working robots will try to pick an article at the same place at the same time, with the result that and work efficiency is reduced due to congestion such as waiting for work. On the other hand, the system 10 acquires the moving routes as described above, for example, through estimation in advance, finds the storage positions on those moving routes, and determines the storage positions of articles in such a way that the work amount is evenly distributed within the determined storage positions.

In addition, the processing in the system 10 does not require the time information such as the chronological information on the work orders but requires only the information indicating the combinations of articles to be processed by the work orders. Therefore, the system 10 can be used even when chronological information is unknown, such as when a new warehouse is launched.

In addition, as described above, the first condition includes a condition that the new position is a storage position to which movement along the moving route indicated by the moving route information is possible, and the calculation unit 12 can calculate at least one assignable position candidate in such a way that this condition is satisfied. In addition, as described above, the calculation unit 12 can calculate, as at least one of the assignable position candidates, a storage position where at least parts of the moving routes indicated by the received moving route information overlap each other in such a way that this condition is satisfied.

In the above scene, it is assumed that, as the information indicating the passages described in (iv) above, a worker or a working robot can move (carry articles) along a passage, indicated by an arrow in FIG. 3, only in the direction of the arrow. That is, all the moving routes indicated by the received moving route information are routes where moving to a storage position is limited to moving from a predetermined direction; in other words, the passage is a one-way passage. Note that, however, this embodiment is not limited to a scene where such restrictions are imposed but that the moving route indicated by the moving route information can also include a two-way passage.

As described above, at least one of the moving routes indicated by the moving route information may be a route calculated as a route that is estimated to be followed when carried articles are carried in or carried out. Note that, however, at least one of the moving routes indicated by the received moving route information may be a moving route determined by, and received from, a person such as an administrator in advance.

Although it is assumed in the above scene that both a single-level shelf and a multi-level shelf are managed in the same manner, the embodiment is not limited thereto. For example, even when the shelves are multi-level shelves and are managed differently, it is only required that the position of a shelf be uniquely identified, for example, in terms of the horizontal position and the level number (or vertical position) of the shelf. In this case too, since the horizontal position of a shelf basically has a significant meaning for the carrying of articles, assignable position candidates may be calculated by considering only the horizontal position of a shelf on which articles are placed.

Although it is assumed in the above scene that a shelf is sufficiently large and any article can be assigned to it, the embodiment is not limited thereto. For example, the article information 14b may include the information indicating the size of an article. In this case, the calculation unit 12 may calculate candidates from among the storage positions that can accommodate an article indicated by the article information. In this case, in step S16, when the article is the article α, the size of each of the shelves SH calculated in step S15 (that is, shelves 1A, 1B, 1C, 4A, 4B, and 4C) is compared with the size of the article α and, if there is a shelf SH which is among the shelves SH and to which the candidates cannot be assigned, such a shelf SH is not extracted.

When the article information 14b includes the information indicating the size of an article, the storage position information may include the information indicating the size of a storage area or the number of pieces that can be stored for each of the above-described articles. Then, based on the article information and the storage position information, the determination unit 13 can determine, as a new position from among the candidates, a storage position where the candidate-calculated article can be stored.

Although only the size of an article is considered, the article information 14b may include the information indicating the weight of an article and, in addition, the storage position information may include the information indicating the maximum storage weight in a storage area. This allows the determination unit 13 to perform the determination processing with consideration for these pieces of information. That is, based on the article information and the storage position information both of which include the information on weight, the determination unit 13 can determine, as a new position from among the assignable position candidates, the storage position where a candidate-calculated article can be stored.

In addition, the article information 14b may include the information indicating an attention level in carrying an article. In this case, based on the information indicating the level, the determination unit 13 may determine, as a new position from among the candidates, a storage position where a candidate-calculated article can be carried and stored without damage.

Next, an alternative example of the processing example in FIG. 5 will be described below.

In the processing example in FIG. 5, the calculation unit 12 first calculates assignable position candidates for all the articles and, then, the determination unit 13 determines assigned positions with less congestion considering all the articles. In this alternative example, the processing is performed for “a part of the articles” instead of “all the articles” and then, by repeating this processing, assigned positions with less congestion can also be determined without increasing the moving distance. That is, in this embodiment, the calculation unit 12 first calculates the assignable position candidates for a part of the articles and, then, the determination unit 13 determines assigned positions with less congestion considering the part of the articles. The same effect can be achieved by repeating this processing as many times as necessary until all of the articles are processed.

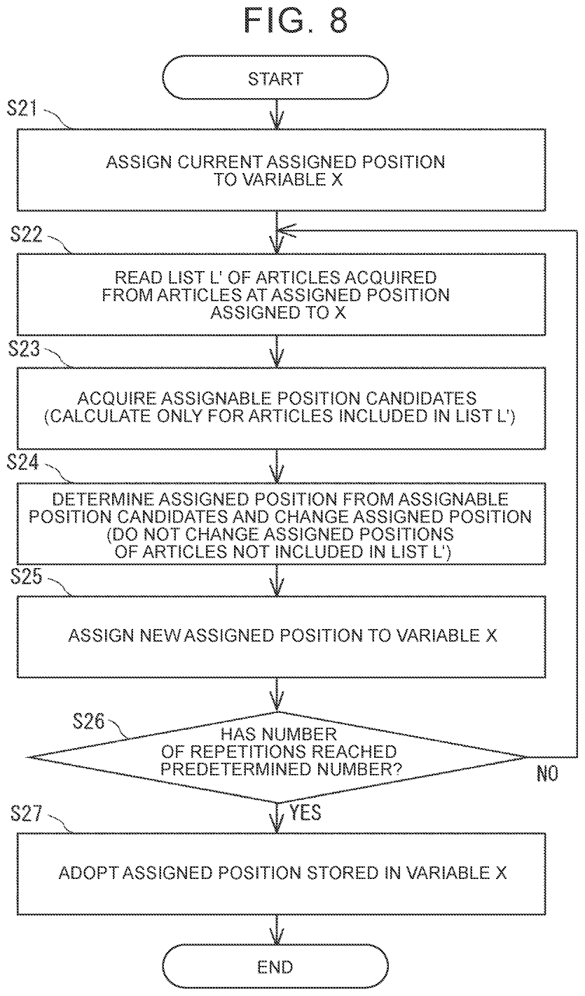

An example of such processing will be described with reference to FIG. 8. FIG. 8 is a flowchart showing, in more detail, another example of the storage position determination processing performed by the storage position determination system 10 shown in FIG. 1.

First, the input unit 11 assigns a current assigned position to the variable X (step S21). For example, the input unit 11 assigns the shelf SH in row 1, column C shown in FIG. 3 to the variable X. Next, the input unit 11 acquires one or more articles from the articles stored in the assigned position assigned to the variable X (articles α and θ in the above example) and passes the acquired articles to the calculation unit 12 as the list L′ (step S22). The articles acquired in this case may be the articles selected randomly or may be the articles assigned to a shelf that is one of the shelves at the current article-assigned position and that has the largest work amount.

Next, the calculation unit 12 uses the same calculation method described in FIG. 5 to calculate the assignable position candidates for the articles in the list L′ and, then, passes the calculated candidates to the determination unit 13 (steps S22, S23). More specifically, using the list L′ instead of the list L that includes the articles to be assigned and is read in step S11 in FIG. 5, the calculation unit 12 performs the processing, shown in FIG. 5, to calculate and set assignable position candidates for all articles included in list L′ and, then, passes the result to the determination unit 13.

Next, the determination unit 13 uses the assignable position candidates for the articles included in the list L′ to determine new assigned positions with the work amount distributed in the same manner as the determination unit 13 described above (step S24). For the articles not included in the list L′, the determination unit 13 does not change the assigned positions. After that, the input unit 11 assigns a new assigned position to the variable X (step S25).

In the system 10, steps S22 to S25 are repeated until a predetermined number of repetitions is reached. Therefore, the input unit 11 determines whether the number of repetitions has reached the predetermined number (step S26). When the number of repetitions has not reached the predetermined number, the processing returns to step S22. When the number of repetitions has reached the predetermined number (YES in step S26), the input unit 11 sends the notification to that effect to the determination unit 13. Then, the determination unit 13 adopts the assigned position, stored in the variable X, as the new assigned position, changes the current assigned position to the new position (step S27), and ends the processing. The new assigned positions determined in this way are assigned positions with less congestion without increasing the moving distance over the distance from the current assigned positions.

Whether to repeat the processing may also be determined, for example, by the threshold value processing for the predetermined time instead of the threshold value processing for the predetermined number of times. That is, in step S26, whether to repeat the processing may also be determined by determining whether the time of repetition has reached the predetermined time.

### Alternative Example

Although the system 10 has been described in the embodiment described above, the storage position determination system is not limited to the configuration shown in the example as long as the system can perform its functions. In addition, each piece of information processed by the storage position determination system is not limited to the information shown in the example but any information that can be used for an equivalent calculation may be used.

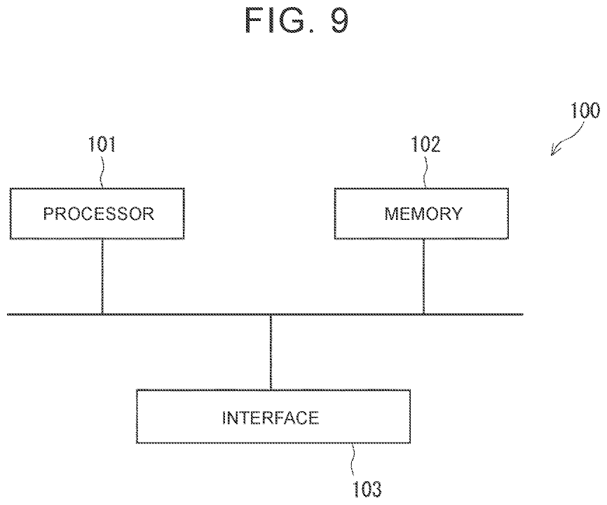

As described for the system 10, the storage position determination system may be configured with the functions distributed over a plurality of devices or may be configured as a single device. Each of these devices or a single device can have, for example, the following hardware configuration. FIG. 9 is a diagram showing an example of the hardware configuration of such a device.

A device 100 shown in FIG. 9 can always include a processor 101, a memory 102, and an interface 103. For example, when the device 100 is a computer, the interface 103 may include interfaces such as an interface with an operation device that accepts a user operation, an interface with a display device that displays information, and a communication interface for sending and receiving information.

The processor 101 may be a unit such as a CPU, a graphics processing unit (GPU), and a microprocessor unit (MPU) also called a microprocessor. The processor 101 may include multiple processors. The memory 102 is configured, for example, by a combination of volatile memory and non-volatile memory. The functions of the multiple devices or the single device described above are implemented by the processor 101 that reads the control program from the memory 102 and executes the control program while exchanging necessary information via the interface 103.

This program includes instructions (or software code) that, when read into a computer, cause the computer to perform one or more functions described in the embodiment. The program may be stored in a non-transitory computer-readable medium or a tangible storage medium. Computer readable media or tangible storage media include, as an example but not limited to, memories such as a random-access memory (RAM), a read-only memory (ROM), a flash memory, a solid-state drive (SSD), or those implemented by other memory techniques, optical disc storage such as a CD-ROM, a digital versatile disc (DVD), a Blu-ray (registered trademark) disc, or other optical disc storage, and magnetic storage devices such as a magnetic cassette, a magnetic tape, a magnetic disk storage, or other magnetic storage. The program may be sent via a transitory computer-readable medium or a communication medium. Transitory computer readable media or communication media include, as an example but not limited to, electrical, optical, acoustic, or other forms of propagated signals.

The present disclosure is not limited to the above-mentioned embodiment, and can be changed as appropriate without departing from the spirit. The present disclosure includes a mode in which the examples in the above embodiment are appropriately combined for execution.

What is claimed is:

1. A storage position determination system configured to:
perform, for each of a plurality of articles to be stored in a predetermined area, input processing configured to receive article information, storage position information, carrying in/out information, and moving route information, the article information indicating the article, the storage position information indicating a storage position when the article is stored, the carrying in/out information indicating, in chronological order, the number of carrying-in pieces of the article and the number of carrying-out pieces of the article, the moving route information indicating moving routes at a time of work for carried articles that are one or more articles indicated by the carrying in/out information and that are carried in or carried out at the same time;
perform calculation processing configured to calculate candidates for a new position of a storage position for at least one of the plurality of articles in such a way that a first condition is satisfied, the first condition being a condition that a moving distance indicated by the moving route information is not increased; and
perform determination processing configured to determine, for a candidate-calculated article, the new position from among the candidates, the candidate-calculated article being an article for which the candidates have been calculated.

2. The storage position determination system according to claim 1, wherein:
the first condition includes a condition that the new position is a storage position to which movement along the moving route indicated by the moving route information is possible and;
the calculation processing is configured to calculate at least one of the candidates in such a way that the condition is satisfied.

3. The storage position determination system according to claim 2, wherein the calculation processing is configured to calculate, as the at least one of the candidates, a storage position where at least parts of the moving routes indicated by the moving route information overlap each other in such a way that the condition is satisfied.

4. The storage position determination system according to claim 1, wherein:
the article information includes information indicating a size of the article; and
the calculation processing is configured to calculate the candidates from among storage positions that are able to accommodate the article indicated by the article information.

5. The storage position determination system according to claim 1, wherein all moving routes indicated by the moving route information are routes where moving to a storage position is limited to moving from a predetermined direction.

6. The storage position determination system according to claim 1, wherein, for an article that is included in the plurality of articles but that is not included in the carrying in/out information or for an article that is included in the plurality of articles but for which the number of carrying-in pieces and the number of carrying-out pieces in the carrying in/out information are zero, the calculation processing is configured not to calculate the candidates or is configured to calculate, as the candidates, the same storage position as the storage position.

7. The storage position determination system according to claim 1, wherein the determination processing is configured to determine the new position from among the candidates in such a way that a work amount required for carrying articles in, and carrying articles out from, storage positions in the predetermined area is distributed over the storage positions.

8. The storage position determination system according to claim 1, wherein:
the article information includes information indicating a size of the article;
the storage position information includes information indicating a size of a storage area or the number of pieces that is able to be stored for each of the plurality of articles; and
the determination processing is configured to determine, as the new position from among the candidates, a storage position where the candidate-calculated article is able to be stored, based on the article information and the storage position information.

9. The storage position determination system according to claim 1, wherein:
the article information includes information indicating an attention level in carrying the article; and
the determination processing is configured to determine, as the new position from among the candidates, a storage position where the candidate-calculated article is able to be carried and stored without damage, based on the information indicating the level.

10. The storage position determination system according to claim 1, wherein at least one of moving routes indicated by the received moving route information is a route calculated as a route that is estimated to be followed when the carried articles are carried in or carried out.

11. A storage position determination method comprising:
performing, for each of a plurality of articles to be stored in a predetermined area, input processing configured to receive article information, storage position information, carrying in/out information, and moving route information, the article information indicating the article, the storage position information indicating a storage position when the article is stored, the carrying in/out information indicating, in chronological order, the number of carrying-in pieces of the article and the number of carrying-out pieces of the article, the moving route information indicating moving routes at a time of work for carried articles that are one or more articles indicated by the carrying in/out information and that are carried in or carried out at the same time;
performing calculation processing configured to calculate candidates for a new position of a storage position for at least one of the plurality of articles in such a way that a first condition is satisfied, the first condition being a condition that a moving distance indicated by the moving route information is not increased; and
performing determination processing configured to determine, for a candidate-calculated article, the new position from among the candidates, the candidate-calculated article being an article for which the candidates have been calculated.

12. A non-transitory storage medium that stores a program causing a computer to:
perform, for each of a plurality of articles to be stored in a predetermined area, input processing configured to receive article information, storage position information, carrying in/out information, and moving route information, the article information indicating the article, the storage position information indicating a storage position when the article is stored, the carrying in/out information indicating, in chronological order, the number of carrying-in pieces of the article and the number of carrying-out pieces of the article, the moving route information indicating moving routes at a time of work for carried articles that are one or more articles indicated by the carrying in/out information and that are carried in or carried out at the same time;
perform calculation processing configured to calculate candidates for a new position of a storage position for at least one of the plurality of articles in such a way that a first condition is satisfied, the first condition being a condition that a moving distance indicated by the moving route information is not increased; and
perform determination processing configured to determine, for a candidate-calculated article, the new position from among the candidates, the candidate-calculated article being an article for which the candidates have been calculated.
